(19) United States
(12) Patent Application Publication
(10) Pub. No.: US 2008/0131662 A1
(43) Pub. Date: Jun. 5, 2008

(54) Alignment of a cap to a MEMS wafer

(76) Inventors: Larry L. Jordan, Kokomo, IN (US); Kay Jordan, Kokomo, IN (US); Heather H. Dibiaso, Kokomo, IN (US)

Correspondence Address: DELPHI TECHNOLOGIES, INC., M/C 480-410-202, PO BOX 5052, TROY, MI, 48007, US

(21) Appl. No.: 11/633,905

(22) Filed: Dec. 5, 2006

(51) Int. Cl. B32B 3/26; B05D 5/12; B05D 3/12

(52) U.S. Cl. 428/141; 427/307; 427/58; 427/125; 427/123

(57) ABSTRACT

An apparatus and method is provided to accurately align a cap wafer relative to a microelectromechanical systems (MEMS) wafer during a bonding process. Other materials may be accurately aligned as well. A trench is established in the MEMS wafer, and a printed substance, secured to the cap wafer, flows into the trench when a pressure is applied to the cap wafer at bond temperature. Natural forces aid in shifting the materials into a lowest energy state and self-aligns the materials into a desired position. The trench also serves as a collection trench for the flowing substance by helping to shape the substance. The trench dimensions may be used to aid in creating a hermetic seal. The alignment tolerances required conventionally during the device design stage are decreased, since the present invention provides a repeatable and accurate alignment bonding process. Chip multiple is increased and therefore chip costs are decreased.

### FIELD OF THE INVENTION

The invention relates generally to microelectromechanical systems (MEMS), and more particularly to accurately aligning a frit printed cap wafer relative to a MEMS wafer.

### BACKGROUND OF THE INVENTION

Microelectromechanical systems (MEMS) are devices that use microfabrication technology to develop mechanical elements linked to electrical components for detection and actuation. MEMS devices are widely used, with common applications including biotechnology, communications, piezoelectrics, accelerometers for collision airbag deployment, pressure sensors, and optical switching. These devices generally range in size from a micrometer to a millimeter. MEMS devices are thus typically manufactured using planar processing similar to semiconductor processes such as surface micromachining and/or bulk micromachining. MEMS technology is implemented using a wide range of different materials and manufacturing techniques, depending on the device being created. Materials used to create MEMS elements include silicon, polymers and metals such as gold, nickel, aluminum, chromium, titanium, tungsten, platinum, and silver.

In many MEMS applications, a cap wafer is bonded to the MEMS device wafer by utilizing a glass frit as the bonding material. In particular MEMS applications, such as an accelerometer, a MEMS device must be hermetically sealed. Here, the glass frit bonds a cap wafer to the MEMS device wafer, creating a hermetic seal about the MEMS device. The conventional bonding process uses visual alignment systems to align the top cap wafer to the MEMS device wafer. These visual alignment systems are typically capable of alignment tolerances of 1 to 2 microns. However, during the bond cycle, when pressure is applied to the top cap wafer to flow the glass frit and complete the bond, the cap wafer frequently moves away from the initial alignment point. This results in an increased alignment tolerance, which must be considered and compensated for during the device design stage. Additionally, the increased alignment tolerance is typically in the range of 1 to 2 mils, resulting in decreased chip multiple and thus increased chip cost.

### SUMMARY OF THE INVENTION

An apparatus and method is provided that accurately aligns a cap wafer relative to a microelectromechanical systems (MEMS) wafer. The method may further be used to precisely situate materials other than a cap and MEMS wafer in a predetermined location, such as those used with integrated circuit microchips and nanotechnology devices. During the bonding process, the present invention cap wafer shifts toward proper alignment, rather than away from an initial alignment point as in many conventional systems. The alignment tolerances required conventionally (i.e., 1 to 2 mils) during the device design stage are decreased, since the present invention provides a repeatable and accurate alignment bonding process. The decreased alignment tolerance results in increased chip multiple and therefore decreased chip cost.

In addition to an alignment trench, the present invention trench serves as a collection trench for the substance situated between the aligned materials. The substance pattern line typically has a desired length, width and depth, which is dependent on the particular application. The dimensions may be intended to create a hermetic seal for the MEMS device, and controlling the substance dimensions impacts the success of creating a hermetic seal. The present invention trenches can aid in shaping the substance seal. Further, in an example, a screen printer forms the substance pattern in a limited range of dimensions, which may be too large for the needed design pattern. The present invention trenches can serve to further reduce the screen printed pattern.

Features of the invention are achieved in part by utilizing naturally occurring forces to shift the materials into a lowest energy state and thereby self-align the materials into a desired position. In an embodiment, a substance such as a glass frit is applied to a cap wafer and the cap wafer is shaped into a pattern using a screen printer. After shaping the substance into a pattern, a predetermined temperature as appropriate to the substance is applied to the substance to drive off any solvent and binder in the substance. Next, a trench is established in a MEMS device. The trench may be etched during formation of the MEMS wafer for considerations including cost. The cap wafer is then visually situated adjacent to the MEMS wafer. A predetermined pressure is applied to the cap wafer at bond temperature, causing a portion of the substance that remains secured to the cap wafer to flow into the trench. The cap wafer is thus spaced and aligned relative to the MEMS wafer via the flowing substance.

In an embodiment, the trench is positioned to receive a major portion of the substance, and the trench is shaped with a predetermined width, length and depth. By receiving the substance, the trench may be utilized to facilitate shaping the substance to have a width less than the conventional range of 150 to 200 microns. A contiguous trench may be established about a perimeter of the MEMS device wherein substantially all of the substance is situated within the trench, while still affixing the cap wafer to the MEMS wafer. Therefore, the substance may be utilized to form a hermetic seal about the MEMS device. In an embodiment, the cap wafer and the MEMS wafer are comprised of one of silicon, a polymer and a metal, wherein the metal includes one of gold, nickel, aluminum, chromium, titanium, tungsten, platinum, and silver.

Other features and advantages of this invention will be apparent to a person of skill in the art who studies the invention disclosure. Therefore, the scope of the invention will be better understood by reference to an example of an embodiment, given with respect to the following figures.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1A is a sectional side view of a cap wafer positioned adjacent to a MEMS device with an intermediate sealing glass frit, following visual alignment to approximately align the same, as used in conventional bonding processes;

FIG. 1B is a sectional side view of the cap wafer and adjacent MEMS device as in FIG. 1A, having added pressure and heat in a subsequent process step, resulting in increased misalignment of the cap wafer relative to the MEMS device and wafer, as employed in conventional bonding processes;

FIG. 2 is a sectional side view of a cap wafer positioned adjacent to a MEMS device with an intermediate sealing glass frit and trench, following visual alignment to approximately align the same, in accordance with an embodiment of the present invention;

FIG. 3 is a sectional side view of the cap wafer and adjacent MEMS device with an intermediate sealing glass frit and trench as in FIG. 2, having added pressure and heat in a subsequent process step where the glass frit is flowing into the trench, in accordance with an embodiment of the present invention;

FIG. 4 is a sectional side view of the cap wafer and adjacent MEMS device with an intermediate sealing glass frit and trench as in FIG. 2, wherein the glass frit has settled in the trench resulting in accurate alignment of the cap wafer relative to the MEMS device and wafer, in accordance with an embodiment of the present invention;

FIG. 5 illustrates example steps in bonding of the device as in FIG. 4, in accordance with an embodiment of the present invention;

FIG. 6A is a top schematic view of an experimental example illustrating the resulting alignment of a conventional process alignment of a cap wafer positioned adjacent to a MEMS wafer;

FIG. 6B is a top schematic view of an experimental example illustrating the resulting alignment of a conventional process alignment of a cap wafer positioned adjacent to a MEMS wafer (after the cap wafer is intentionally misaligned a distance of 50 microns);

FIG. 7A is a top schematic view of an experimental example illustrating the resulting alignment of a present invention alignment of a cap wafer positioned adjacent to a MEMS wafer, in accordance with an embodiment of the present invention; and

FIG. 7B is a top schematic view of an experimental example illustrating the resulting alignment of a present invention alignment of a cap wafer positioned adjacent to a MEMS wafer (after the cap wafer is intentionally misaligned a distance of 50 microns), in accordance with an embodiment of the present invention.

### DETAILED DESCRIPTION OF THE INVENTION

Exemplary embodiments are described with reference to specific configurations. Those of ordinary skill in the art will appreciate that various changes and modifications can be made while remaining within the scope of the appended claims. Additionally, well-known elements, devices, components, methods, process steps and the like may not be set forth in detail in order to avoid obscuring the invention. Further, unless indicated to the contrary, the numerical values set forth in the following specification and claims are approximations that may vary depending upon the desired characteristics sought to be obtained by the present invention.

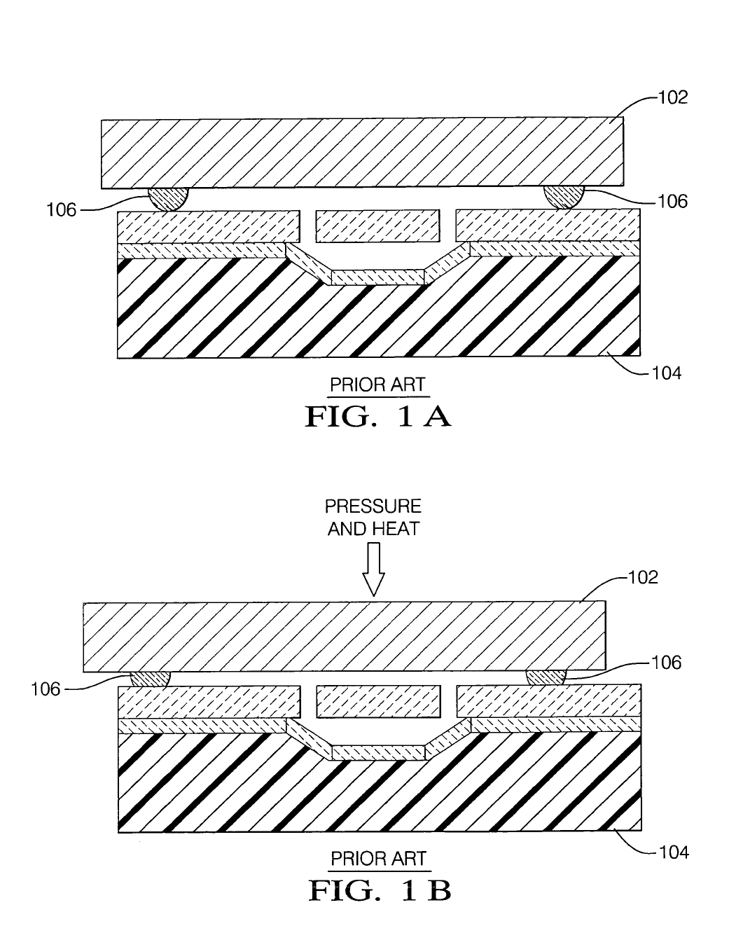

In microelectromechanical systems (MEMS) applications, a cap wafer is often bonded to a MEMS device wafer by utilizing a glass frit bonding material. In some applications, such as an accelerometer, a hermetic seal is established. Referring to the drawings wherein identical reference numerals denote the same elements throughout the various views, FIG. 1A illustrates a sectional side view of a cap wafer positioned adjacent to a MEMS device with an intermediate sealing glass frit, as used in conventional bonding processes. The conventional bonding process uses visual alignment systems to align the cap wafer 102 to the MEMS device 104, which, given the small dimensions of the device, introduces alignment error. These visual alignment systems are typically capable of alignment tolerances of 1 to 2 microns. Further, during the bond cycle, when pressure and heat is applied to the cap wafer 102 to flow the glass frit 106 and complete the bond, the cap wafer 102 frequently moves away from the initial alignment point. This results in an increased alignment tolerance (misalignment), which must be considered and compensated for during the device design stage. Additionally, the increased alignment tolerance is typically in the range of 1 to 2 mils, resulting in decreased chip multiple and thus increased chip cost. FIG. 1B shows a sectional side view of the cap wafer 102 and adjacent MEMS device 104, having added pressure and heat in a subsequent process step, resulting in increased misalignment of the cap wafer 102 relative to the MEMS device 104 and MEMS wafer, as employed in conventional bonding processes.

Turning again now to the present invention, an apparatus and method is provided that accurately aligns a top cap wafer relative to a microelectromechanical systems (MEMS) wafer. It is to be appreciated that the present invention method may further be used to precisely situate materials other than a cap and MEMS wafer in a predetermined location, such as those used with integrated circuit microchips and nanotechnology devices.

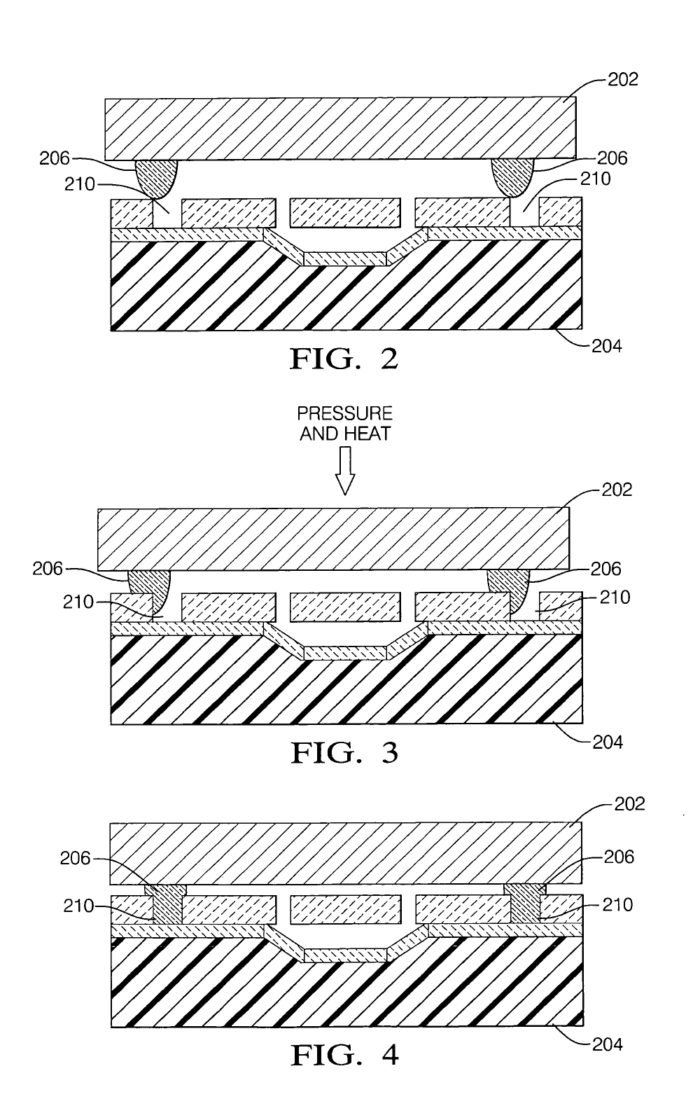

FIG. 2 illustrates a sectional side view of a cap wafer 202 positioned adjacent to a MEMS device 204 with an intermediate sealing glass frit 206 and trench 210, following visual alignment to approximately align the same, in accordance with an embodiment of the present invention. Typically, due to the small dimensions of the device, the visual alignment imprecisely, aligns the cap wafer 202 to the MEMS device 204 and MEMS wafer, as depicted in FIG. 2. Although one MEMS device 204 is shown, it is to be understood that a plurality of MEMS devices may be situated on a MEMS wafer. Next, as shown in FIG. 3, pressure and heat are applied during the bonding process. The pressure and temperature applied are those as appropriate to the substance, as understood by those skilled in the art. The glass frit 206 begins to flow into the trench 210, and the cap wafer 202 shifts toward proper alignment, rather than further away from proper alignment as in many conventional systems.

As illustrated in FIG. 4, the glass frit 206 settles in the trench 210 resulting in accurate alignment of the cap wafer 202 relative to the MEMS device 204 and MEMS wafer. The naturally occurring forces, including gravitational forces, shift the cap wafer 202 into a lowest energy state and thereby self-aligns the cap wafer 202 relative to the MEMS device 204 and MEMS wafer into a desired position. The alignment tolerances required conventionally (i.e., 1 to 2 mils) during the device design stage are decreased, since the present invention provides a repeatable and accurate alignment bonding process. The decreased alignment tolerance results in increased chip multiple and therefore decreased chip cost.

The present invention trench 210 serves as an alignment trench, while additionally serving as a collection trench for the glass frit 206. The trench 210 aids in shaping the glass frit seal. In an example, a screen printer forms the glass frit pattern in a limited range of dimensions, which may be too large for the needed design frit pattern. The trench 210 thus serves to further reduce the screen printed pattern. Also, in an embodiment, the trench 210 is positioned to receive a major portion of the glass frit 206, and the trench 210 is shaped with a predetermined width, length and depth. By receiving the glass frit 206, the trench 210 may be utilized to facilitate shaping the glass frit 206 to have a width less than the conventional range of 150 to 200 microns. A contiguous trench may be established about a perimeter of the MEMS device 204 wherein substantially all of the glass frit 206 is situated within the trench 210, affixing the cap wafer 202 to the MEMS device 204 and MEMS wafer. Therefore, the glass frit 206 may be utilized to form a hermetic seal about the MEMS device 204. In an embodiment, the cap wafer 202 and the MEMS device 204 and MEMS wafer are comprised of one of silicon, a polymer and a metal, wherein the metal includes one of gold, nickel, aluminum, chromium, titanium, tungsten, platinum, and silver.

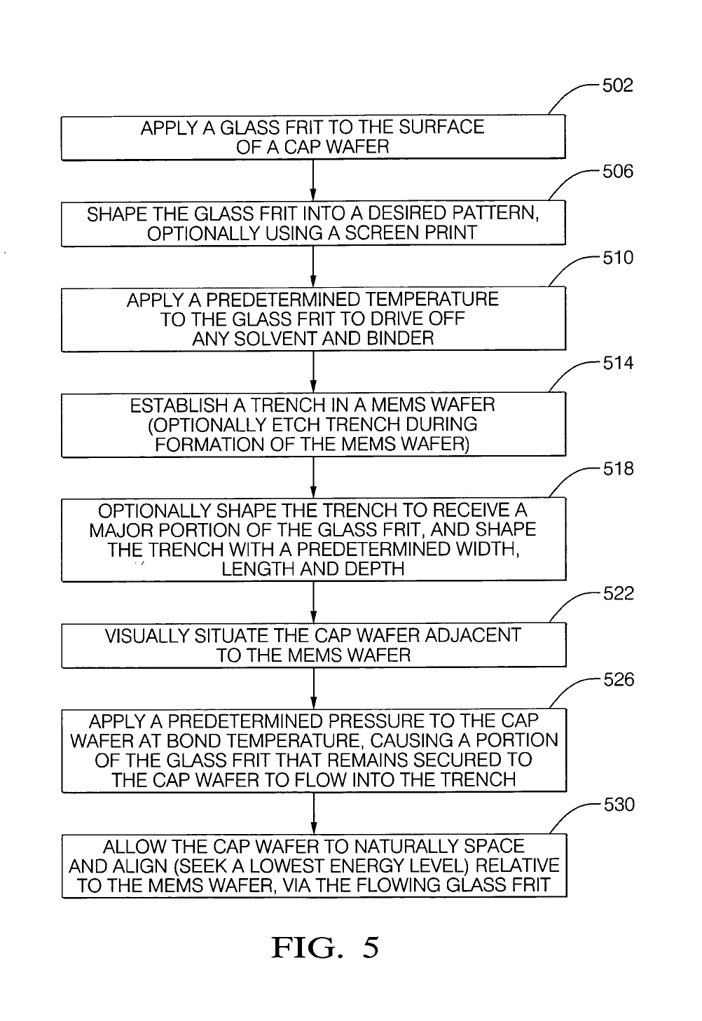

FIG. 5 illustrates example steps in bonding of the device as in FIG. 4, in accordance with an embodiment of the present invention. It is to be appreciated that particular steps described herein may be varied, as known to those skilled in the art, depending on the intended purpose of the MEMS device. In step 502, a substance such as a glass frit is applied to a cap wafer. In step 506, the cap wafer is shaped into a pattern, optionally using a screen printer. It is to be appreciated that the cap wafer may be shaped into a pattern utilizing devices other than a screen printer, and the present invention may likewise be employed although the other devices are utilized. After shaping the substance into a pattern, in step 510, a predetermined temperature as appropriate to the substance is applied to the substance to drive off any solvent and binder in the substance. Next, in step 514, a trench is established in a MEMS device. The trench may be etched during formation of the MEMS wafer for considerations including cost. Optionally, in step 518, shape the trench to receive a major portion of the glass frit, and shape the trench with a predetermined width, length and depth. In step 522, the cap wafer is visually situated adjacent to the MEMS wafer. In step 526, a predetermined pressure is applied to the cap wafer at bond temperature, causing a portion of the substance that remains secured to the cap wafer to flow into the trench. In step 530, the cap wafer is allowed to naturally seeking a lowest energy level, and space and align relative to the MEMS wafer via the flowing substance.

A further understanding of the above description can be obtained by reference to the following experimental result examples that are provided for illustrative purposes and are not intended to be limiting.

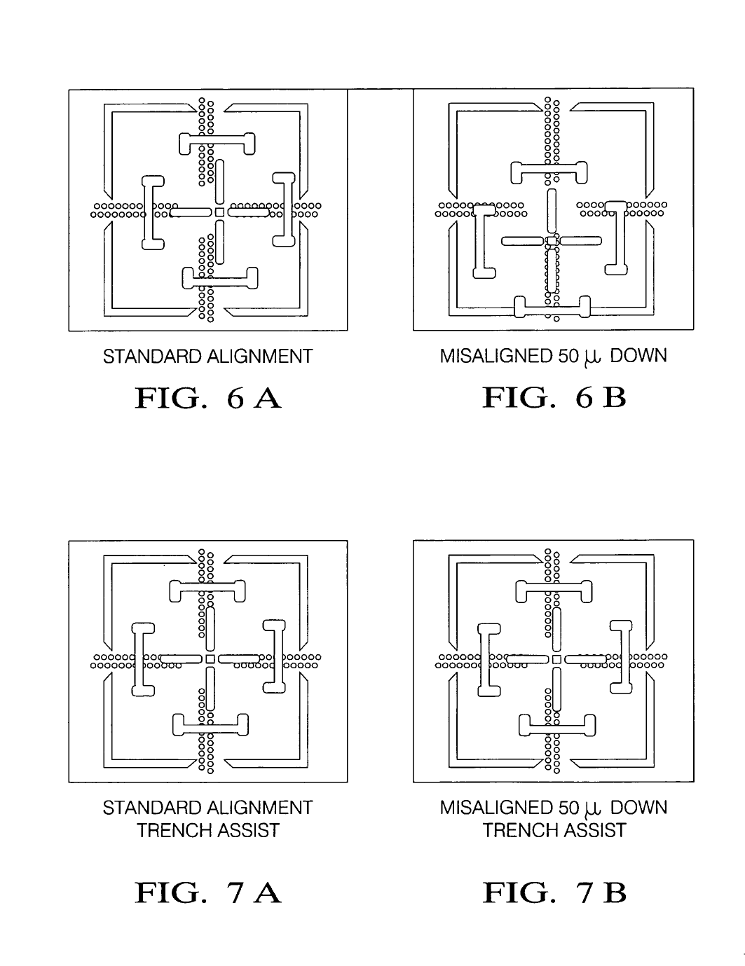

Referring to FIG. 6A, a top schematic view of an experimental example illustrates the resulting alignment of a conventional process alignment of a cap wafer positioned adjacent to a MEMS wafer. As shown, the cap wafer fails to properly align relative to the MEMS wafer. As described above, this is due to the visual alignment error, which is increased when pressure and heat are applied to the cap wafer to flow the glass frit and complete the bond. This misalignment results in decreased chip multiple and thus increased chip cost.

FIG. 6B is a top schematic view of an experimental example illustrating the resulting alignment of a conventional process alignment of a cap wafer positioned adjacent to a MEMS wafer (after the cap wafer is intentionally misaligned a distance of 50 microns). When the bonding process pressure and heat are applied to the cap wafer to flow the glass frit and complete the bond, the cap wafer has no physical reason to more accurately align as compared to the visual alignment.

FIG. 7A is a top schematic view of an experimental example illustrating the resulting alignment of a present invention alignment of a cap wafer positioned adjacent to a MEMS wafer, in accordance with an embodiment of the present invention. As shown, the cap wafer properly aligns relative to the MEMS wafer when pressure and heat are applied to the cap wafer to flow the glass frit into the trench and complete the bond. This proper alignment results in increased chip multiple and thus decreased chip cost.

FIG. 7B is a top schematic view of an experimental example illustrating the resulting alignment of a present invention alignment of a cap wafer positioned adjacent to a MEMS wafer (after the cap wafer is intentionally misaligned a distance of 50 microns), in accordance with an embodiment of the present invention. As shown, when the bonding process pressure and heat are applied to the cap wafer to flow the glass frit into the trench and complete the bond, the cap wafer accurately aligns relative to the MEMS wafer, since the cap wafer naturally seeks a lowest energy level.

Other features and advantages of this invention will be apparent to a person of skill in the art who studies this disclosure. Thus, exemplary embodiments, modifications and variations may be made to the disclosed embodiments while remaining within the spirit and scope of the invention as defined by the appended claims.

1. A method of positioning a first material in a predetermined location relative to a second material, comprising:
applying a substance to the first material;
shaping the substance into a pattern;
establishing a trench defined in the second material;
situating the first material adjacent to the second material; and
applying a predetermined pressure and temperature to the first material to cause a portion of the substance that remains secured to the first material to flow into the trench, and spacing and aligning the first material relative to the second material via the flowing substance.

2. The method as in claim 1, wherein the first material is a cap wafer and the second material is a microelectromechanical systems (MEMS) device wafer.

3. The method as in claim 1, wherein shaping the substance into a pattern comprises forming the substance into a predetermined pattern utilizing a screen printer.

4. The method as in claim 1, further comprising applying a predetermined temperature to the substance to drive off solvent and binder in the substance, after shaping the substance into a pattern.

5. The method as in claim 1, wherein establishing the trench comprises etching the trench into the second material during formation of the second material.

6. The method as in claim 1, wherein establishing a trench in the second material comprises positioned the trench to receive a major portion of the substance and shaping the trench with a predetermined width, length and depth.

7. The method as in claim 6, further comprising utilizing the trench to facilitate shaping the substance to have a width less than 175 microns.

8. The method as in claim 1, wherein establishing a trench comprises establishing a contiguous trench about a perimeter of a device on the second material wherein substantially all of the substance is situated within the trench, affixing the first material to the second material.

9. The method as in claim 1, further comprising utilizing the substance to form a hermetic seal about at least a portion of a device on the second material.

10. The method as in claim 1, wherein situating the first material adjacent to the second material comprises visually placing the first material adjacent to the second material.

11. The method as in claim 1, wherein the substance is a glass frit, and the first material and the second material are comprised of one of silicon, a polymer and a metal, wherein the metal includes one of gold, nickel, aluminum, chromium, titanium, tungsten, platinum, and silver.

12. A method of positioning a cap wafer in a predetermined location relative to a microelectromechanical systems (MEMS) wafer, comprising:
applying a substance to the cap wafer;
shaping the substance into a pattern;
establishing a trench defined in the MEMS wafer;
visually placing the cap wafer adjacent to the MEMS wafer; and
applying a predetermined pressure and temperature to the cap wafer to cause a portion of the substance that remains secured to the cap wafer to flow into the trench, and spacing and aligning the cap wafer relative to the MEMS wafer via the flowing substance.

13. The method as in claim 12, wherein shaping the substance into a pattern comprises forming the substance into a predetermined pattern utilizing a screen printer.

14. The method as in claim 12, further comprising applying a predetermined temperature to the substance to drive off solvent and binder in the substance, after shaping the substance into a pattern.

15. The method as in claim 12, wherein establishing the trench comprises etching the trench into the MEMS wafer during formation of the MEMS wafer.

16. The method as in claim 12, wherein establishing a trench comprises establishing a contiguous trench about a perimeter of a MEMS device on the MEMS wafer wherein substantially all of the substance is situated within the trench, affixing the cap wafer to the MEMS wafer, and forming a hermetic seal about at least a portion of the MEMS device.

17. The method as in claim 12, wherein the substance is a glass frit, and the cap wafer and the MEMS wafer are one of silicon, a polymer and a metal, wherein the metal includes one of gold, nickel, aluminum, chromium, titanium, tungsten, platinum, and silver.

18. A microelectromechanical system (MEMS) wafer having a connected cap wafer, comprising:
a substance, adhered to the cap wafer, shaped in a predetermined pattern; and
a trench defined in the MEMS wafer, wherein a first portion of the substance is adhered to the cap wafer and a second portion of the substance is situated within the trench.

19. The apparatus as in claim 18, wherein the trench is contiguously formed about a perimeter of a MEMS device on the MEMS wafer, wherein the substance forms a hermetic seal about the MEMS device, and wherein substantially all of the substance is situated within the trench, affixing the cap wafer to the MEMS wafer.

20. The apparatus as in claim 18, wherein the substance is a glass frit, and the cap wafer and the MEMS wafer are comprised of one of silicon, a polymer and a metal, wherein the metal includes one of gold, nickel, aluminum, chromium, titanium, tungsten, platinum, and silver.
